(19) United States
(12) Patent Application Publication
(10) Pub. No.: US 2010/0251372 A1
(43) Pub. Date: Sep. 30, 2010

(54) DEMAND SCHEDULED EMAIL VIRUS AFTERBURNER APPARATUS, METHOD, AND SYSTEM

(75) Inventors: DALE ALLEN LUCK, Campbell, CA (US); Zachary Levow, Mountain View, CA (US)

Correspondence Address: PATENTRY, P.O. BOX 151616, SAN RAFAEL, CA, 94915-1616, US

(73) Assignee: BARRACUDA NETWORKS, INC, Campbell, CA (US)

(21) Appl. No.: 12/431,757

(22) Filed: Apr. 29, 2009

Related U.S. Application Data
(63) Continuation-in-part of application No. 12/409,504, filed on Mar. 24, 2009.

(51) Int. Cl. G06F 12/14

(52) U.S. Cl. 726/24

(57) ABSTRACT

Queuing and rescanning email for most recently detected virus signatures. An apparatus comprising a first virus scanning circuit operating on received email and a second virus scanning circuit operating on the outbound email queue and quarantine store. Rescanning for viruses while delivering email to downstream email server or viewing quarantine with virus signatures not previously known when the virus was first introduced to the wild. A circuit determines that an email server or an email client is active and ready to retrieve or read emails from quarantine or from the output queue of a an anti-virus, anti-spam appliance. Upon that condition, one or more virus signatures are read from a most recently discovered virus signature syndication server. Emails in the output queue, or quarantine or rescanned before transmission to the destination email server.

This application is a continuation in part of currently pending US non-provisional utility patent application Ser. No. 12/409,504 first named inventor Zachary Levow, filed Mar. 24, 2009 RECALLING SPAM EMAIL AND VIRUSES FROM INBOXES, of which specification is incorporated by reference in its entirety.

### BACKGROUND

It is known that computer viruses are created and distributed world-wide in a very short time by the use of bot-nets, collections of computers which have become infected and controlled remotely from their owners. It is known that anti-virus groups are alert for reports of widespread virus, analyze them after they have been detected and make available virus signatures as quickly as possible to anti-virus software tools. However, it can be appreciated that before updated virus signature libraries can be distributed to all anti-virus software tools, some emails will be passed through without recognition because the virus transmitter often controls when emails are presented to anti-virus software tools and has the ability to disguise or modify the virus over time to frustrate recognition. It is known that some email end-users with intermittent connections (such as dial-up connections), utilize client with protocols which allow these users to retrieve e-mail when connected and then to view and manipulate the retrieved messages without needing to stay connected. It is known that due to time of day, day of week, work, school, or personal nature of the email address, and bandwidth considerations, some email clients and some email servers are not immediately connected or available for reception of email traffic. Thus it can be appreciated that what is needed is a way to maximize an opportunity to detect a virus without significantly delaying a user's access to his email.

### SUMMARY OF THE INVENTION

The present invention is a method for operating an apparatus for protecting an email server from spam and viruses. The apparatus comprises a first and a second virus scanner circuit coupled to an email queue store. The email queue store is further coupled to a spam filter circuit which is coupled to an email quarantine store. The first virus scanner circuit operates on incoming email on reception to the apparatus to exclude viruses from entering the email queue store. At least one spam filter circuit moves suspicious email to an email quarantine store where it is prevented from download to a destination email server but may be examined by an addressee or an administrator. After an email has been processed by the spam filter circuit it is assigned either in the outbound email queue store or in email quarantine store. The second virus scanner circuit operates on the email quarantine store when an addressee chooses to view an email in the email quarantine store. The second virus scanner circuit operates on the outbound email queue store when a destination email server is connecting to the apparatus to transfer emails. The second virus scanner circuit, referred to in the detailed disclosure as a virus afterburner circuit, obtains most recently discovered virus signatures and virus scanning software which was not available to the first virus scanner circuit at email reception.

### BRIEF DESCRIPTION OF DRAWINGS

FIG. 1 shows a block diagram of a typical computing system.

FIG. 2 shows a block diagram of a spam filter and a conventional email system.

FIG. 3 shows a block diagram of a best mode of the present invention.

### DETAILED DISCLOSURE OF EMBODIMENTS OF THE INVENTION

The embodiments discussed herein are illustrative of one example of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the scope of the present invention. Hence, these descriptions and drawings should not be considered in a limiting sense, as it is understood that the present invention is in no way limited to only the embodiments illustrated.

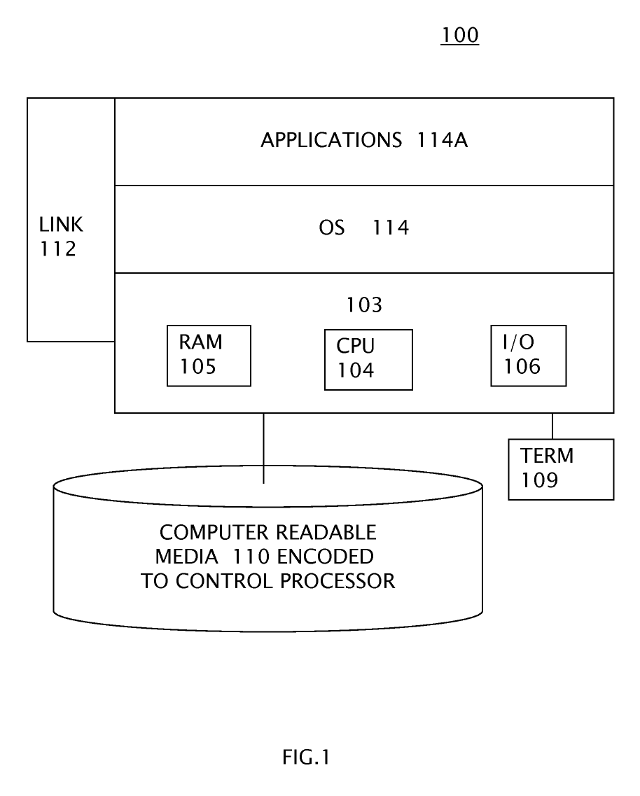

FIG. 1 shows a block diagram of a typical computing system 100 where the preferred embodiment of this invention can be practiced. The computer system 100 includes a computer platform having a hardware unit 103, that implements the methods disclosed below. The hardware unit 103 typically includes one or more central processing units (CPUs) 104, a memory 105 that may include a random access memory (RAM), and an input/output (I/O) interface 106. Microinstruction code 107, may also be included on the platform 102. Various peripheral components may be connected to the computer platform 102. Typically provided peripheral components include an external data storage device (e.g. flash, tape or disk) 110 where the data used by the preferred embodiment is stored. A link 112 may also be included to connect the system 100 to one or more other similar computer systems. The link 112 may also provide access to the global Internet. An operating system (OS) 114 coordinates the operation of the various components of the computer system 100, and is also responsible for managing various objects and files, and for recording certain information regarding same. Lying above the OS 114 is an applications and software tools layer 114A containing, for example, compilers, interpreters and other software tools. The applications 114A run above the operating system and enable the execution of programs using the methods known to the art.

An example of a suitable CPU is a Xeon™ processor (trademark of the Intel Corporation); examples of an operating systems is GNU/Linux; examples of an interpreter and a compiler are a Perl interpreter and a C++ compiler. Those skilled in the art will realize that one could substitute other examples of computing systems, processors, operating systems and tools for those mentioned above. As such, the teachings of this invention are not to be construed to be limited in any way to the specific architecture and components depicted in FIG. 1. It is understood that an embodiment of a circuit is a processor and an embodiment of an apparatus is a computer system as illustrated in this figure.

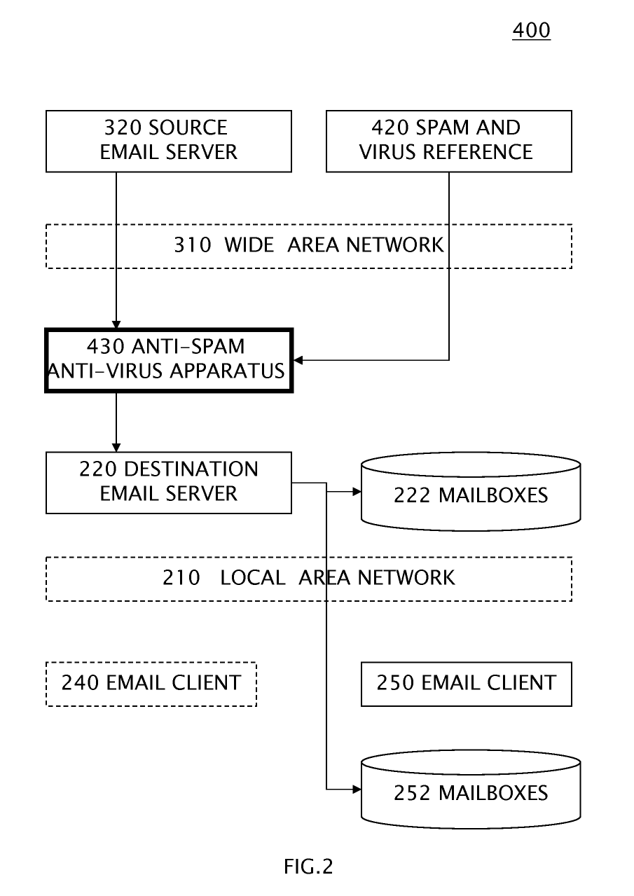

FIG. 2 is a block diagram illustration of a conventional email system with an anti-spam anti-virus appliance installed. In FIG. 2, an apparatus 430 connects to an external spam and virus reference library 420 to request an update to its anti-spam and virus signatures and anti-virus software.

An embodiment of the present invention is a method for operating an apparatus for protection of a destination email server from spam and viruses, the apparatus comprising:
a first virus filter for receiving incoming email,
an email queue store, coupled to the first virus filter,
a plurality of spam filter circuits coupled to the email queue store,
an email quarantine store coupled to the spam filter circuits,
a virus afterburner circuit coupled to the email quarantine store and further coupled to the email queue store, and
an outbound email transmission circuit coupled to the virus afterburner circuit.

An embodiment of the method comprises:
receiving an incoming email from a source email server,
scanning the incoming email for virus signatures and storing into email queue store if no virus signature is found,
scanning the email in the email queue store for spam attributes and moving the email to a quarantine store if certain attributes are found,
obtaining updated virus signatures when a user or a destination email server connects to the apparatus,
upon the condition a user selects an email in quarantine store to view, scanning the selected email in quarantine store with updated virus signatures, and
upon the condition a destination email server connects to the apparatus, scanning the outbound email queue with updated virus signatures addressed to the destination email server;
   whereby,
   an email containing a virus is deleted and the destination email server and its clients may be protected from infection even by a virus discovered after the email has been received by the apparatus.

In an embodiment, scanning the incoming email for virus signatures comprises computing a fingerprint for the email and each attachment, comparing the fingerprint with a database of fingerprints known to correspond to viruses and storing said fingerprint into the header of the email if no match is found.

In an embodiment, obtaining updated virus signatures further comprises obtaining updated anti-virus software.

In an embodiment, the process of scanning the selected email in quarantine store further comprises scanning with updated anti-virus software.

In an embodiment, the process of scanning the outbound email queue further comprises scanning with updated anti-virus software.

The present invention is a computer-implemented method for operating an apparatus. The apparatus comprises circuits which in an embodiment is a processor controlled by computer executable instructions tangibly embodied on computer-readable media encoded with a program product to adapt a processor to perform the steps following:
receiving inbound email addressed to a certain destination IP address,
storing received email into an email queue store,
scanning email in email queue store with inbound spam and virus filters,
disposing of email failing spam and virus filters
marking email ready for outbound transmission which do not fail spam and virus filters,
on the condition that the outbound email transmission circuit determines that a destination email server is available,
retrieving most recently detected virus signatures from a virus reference syndication server,
selecting all mail in the email queue store marked ready for outbound email transmission to the destination email server IP address,
rescanning selected email with most recently detected virus signatures in a virus afterburner circuit, and
transmitting only selected email which pass the rescanning step to the destination email server.

The apparatus is coupled through conventional networks to conventional email clients and servers and to a library reference of virus signatures, fingerprints or patterns.

In an embodiment, disposing of email comprises marking for quarantine, and notifying a user. On the condition that the user wishes to view the quarantine, the method further comprises the steps:
retrieving most recently detected virus signatures from a virus reference syndication server,
selecting all mail in the email queue store marked for quarantine addressed to the user,
rescanning selected email with most recently detected virus signatures in a virus afterburner circuit, and
displaying only selected email which pass the rescanning step to the user.

In an embodiment, scanning inbound email comprises computing and recording a signature into a header of an email whereby rescanning for a virus signature can be done without recomputing a signature.

In an embodiment, the present invention further comprises the steps:
retaining an email and its id after transmission to the destination email server,
scanning recently transmitted emails upon the condition that most recently detected virus signatures are received after transmission,
marking said emails as infected with a virus and within a circuit in a client,
retrieving a unique message id of a recently transmitted email before displaying said email infected with a virus.

In an embodiment, upon the condition that a user forwards an email to another user, the retrieval and scanning is triggered.

In an embodiment, upon the condition that a user moves an email from one folder to another, the retrieval and scanning is triggered.

In an embodiment, upon the condition that email is archived, the retrieval and scanning is triggered.

In an embodiment, upon the condition that a client sends a POP or IMAP retrieve command to the email server, the retrieval and scanning is triggered.

In an embodiment, upon the condition that a client sends a SMTP connect command to the email server, the retrieval and scanning is triggered.

The present invention is embodied in an apparatus comprising
an email queue store, the email queue store coupled to
a plurality of spam filtration circuits; the email queue store further coupled to
an inbound email reception circuit; and
an inbound virus filtration circuit;
an outbound email transmission circuit; couples the email queue store to a destination email server, the outbound email transmission circuit is further coupled to
an outbound virus afterburner circuit; and
a most recent virus signature syndication reader circuit.

In an embodiment, the apparatus further comprises a quarantine store, and a quarantine viewing circuit. This prevents suspicious looking email from being transmitted to a client.

In an embodiment, the apparatus further comprises a garbling circuit, whereby malicious but obfuscated executable codes may be slightly modified to avoid automatic execution.

In an embodiment, the apparatus further comprises a recently transmitted virus database which can be queried by a client before opening an email.

In an embodiment, the apparatus further comprises a recently transmitted email log which can be used to scan for recently discovered virus even after the email has been transmitted to the email server but hopefully before being opened by the user.

The present invention is embodied as a system comprising:
Apparatus coupled to a wide area network coupled to a plurality of email sources,
Apparatus further coupled to a network coupled to one or more email servers corresponding to destination IP addresses which intermittently receive email and intermittently transmit email to clients,
Apparatus further coupled to at least one virus reference syndication server

In an embodiment the system further comprises a circuit in a client to check a recently transmitted virus database for message id's which should not be opened.

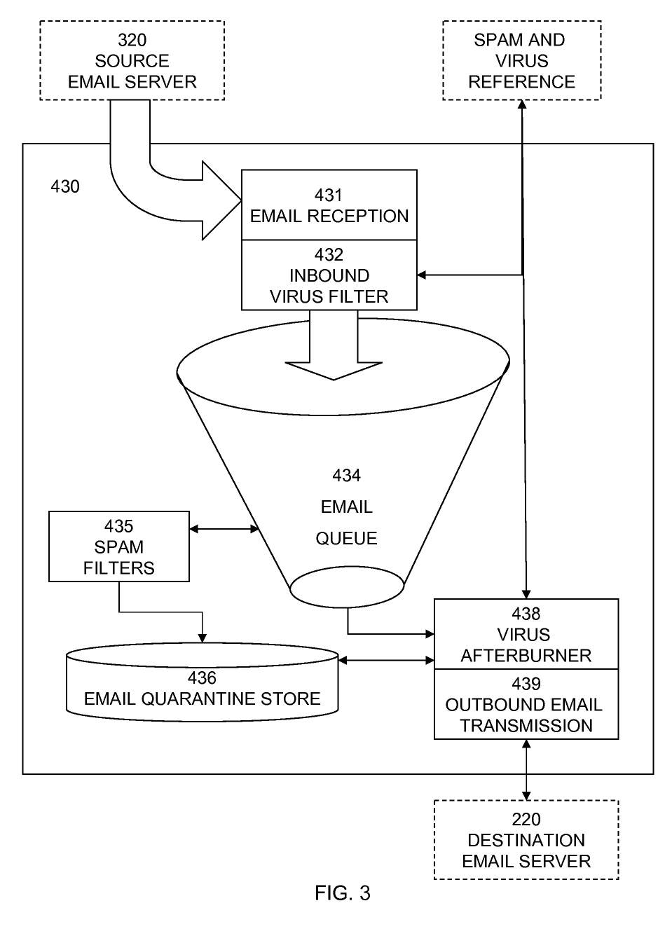

Referring to FIG. 3 an embodiment of the invention is a method of operating an apparatus comprised of
an inbound virus filter circuit 432, coupled to
an email queue store 434,
a virus afterburner circuit 438 further coupled to the email queue store,
the inbound virus filter circuit and the virus afterburner circuit both coupled to a master virus database,
the inbound virus filter further coupled to an email reception circuit 431,
the virus afterburner circuit further coupled to an outbound email transmission circuit 439.

An embodiment of the present invention comprises
an email queue store 434 coupled to
an inbound virus filter circuit 432,
a virus afterburner circuit 438 further coupled to the email queue store,
a plurality of spam filter circuits 435 further coupled to the email queue store;
the spam filter circuits further coupled to an email quarantine store 436, the email quarantine store further coupled to the virus afterburner circuit, the virus afterburner circuit further coupled to through a network, in an embodiment a wide area network, to a master virus database, an outbound email transmission circuit further coupled to the virus after burner circuit, a destination email server coupled to the outbound email transmission circuit through a network, in an embodiment a local area network, the inbound virus filter is further coupled to an email reception circuit 431, and further coupled to the master virus database, the email reception circuit is further coupled to at least one source email server 320 through a network, in an embodiment a wide area network.

The present invention comprises a master virus database coupled to an apparatus 430, the apparatus coupled through a network, in an embodiment a wide area network such as the Internet, to a source email server 320, the apparatus further coupled through a network, in an embodiment a local area network, in an embodiment an Ethernet, to a destination email server 220.

### CONCLUSION

In conventional anti-virus firewalls, virus scanning occurs as early as possible to prevent intrusion of emails containing the virus into the network. The present invention is distinguished by obtaining updated virus signatures and anti-virus software upon the condition that a user selects an email in quarantine to view or upon the destination email server connecting to the apparatus and by rescanning the email prior to completion of the transfer. The burden is reduced by eliminating a large percentage of emails discarded by spam filtering. The burden is further reduced by avoiding emails are addressed to users not known or deactivated on the destination email server. The accuracy is improved by potentially accessing a more current virus signature database than when the email was initially transmitted from the source email server to the apparatus.

The present invention is distinguished from conventional anti-virus appliances by having an output queue store and a virus afterburner circuit in addition to conventional circuits for receiving and transmitting emails, circuits for retrieving spam and virus signatures, circuits for scanning emails, and circuits for disposing of email which fail the scanning step. Upon the condition that an email server indicates it is available to receive email from the apparatus, the present invention performs the methods of
reading a virus pattern syndication feed for the most recently discovered threats,
selecting emails in the output queue of the apparatus with destination IP addresses of the email server,
scanning the selected emails output queue of the apparatus for the most recently discovered threats, and
transferring email that pass the scanning step to the email server interface.

Various other equivalent triggers are disclosed to trigger obtaining a virus signature and using it immediately before transmitting an email to an email server. Additionally, recently transmitted email is also scanned when a recently discovered virus signature is obtained. Thus an enhanced client such as a smart phone with a application can check for message id's of infected emails prior to displaying them.

The above-described functions can be comprised of executable instructions that are stored on storage media. The executable instructions can be retrieved and executed by a processor. Some examples of executable instructions are software, program code, and firmware. Some examples of storage media are memory devices, tape, disks, integrated circuits, and servers. The executable instructions are operational when executed by the processor to direct the processor to operate in accord with the invention. Those skilled in the art are familiar with executable instructions, processor(s), and storage media.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A method for operating an apparatus for protection of an email server from spam and viruses, the apparatus comprising:
a first virus filter for receiving incoming email,
an email queue store, coupled to the first virus filter,
a plurality of spam filter circuits coupled to the email queue store,
an email quarantine store coupled to the spam filter circuits,
a virus afterburner circuit coupled to the email quarantine store and further coupled to the email queue store, and
an outbound email transmission circuit coupled to the virus afterburner circuit;
the method comprising:
receiving an incoming email from a source email server,
scanning the incoming email for virus signatures and storing into email queue store if no virus signature is found,
scanning the email in the email queue store for spam attributes and moving the email to a quarantine store if certain attributes are found,
obtaining updated virus signatures when a user or a destination email server connects to the apparatus,
upon the condition a user selects an email in quarantine store to view, scanning the selected email in quarantine store with updated virus signatures, and
upon the condition a destination email server connects to the apparatus, scanning the outbound email queue with updated virus signatures addressed to the destination email server;
whereby an email containing a virus is deleted and the destination email server and its clients may be protected from infection even by a virus discovered after the email has been received by the apparatus.

2. The method of claim 1 wherein scanning the incoming email for virus signatures comprises computing a fingerprint for the email and each attachment, comparing the fingerprint with a database of fingerprints known to correspond to viruses and storing said fingerprint into the header of the email if no match is found.

3. The method of claim 1 wherein obtaining updated virus signatures further comprises obtaining updated anti-virus software.

4. The method of claim 1 wherein the process of scanning the selected email in quarantine store further comprises scanning with updated anti-virus software.

5. The method of claim 1 wherein the process of scanning the outbound email queue further comprises scanning with updated anti-virus software.

6. An apparatus comprising
an email queue store;
a plurality of spam filtration circuits;
an inbound email reception circuit;
an inbound virus filtration circuit;
an outbound email transmission circuit;
an outbound virus afterburner circuit; and
a most recent virus signature syndication reader circuit.

7. The apparatus of claim 6, further comprising
a quarantine store, and a quarantine viewing circuit,

8. The apparatus of claim 6, further comprising
a recently transmitted virus database and a recently transmitted email log whereby a client may check if a virus has been discovered in an email which has been downloaded but not yet opened on the client.

9. A system for protection of a destination email server from spam and viruses comprising:
an apparatus coupled to a wide area network coupled to a plurality of email sources,
the apparatus further coupled to a network coupled to one or more email servers corresponding to destination IP addresses which intermittently receive email and intermittently transmit email to clients,
the apparatus further coupled to at least one virus reference syndication server. and,
a circuit in a client to check a recently transmitted virus database.

10. A method for operating an apparatus comprising
a spam filter circuit,
an output queue store,
an email server interface,
a virus pattern syndication reader circuit, and
a virus afterburner circuit;
the method comprising the processes of
upon the condition that an email server indicates it is available to receive email from the apparatus,
reading a virus pattern syndication feed for the most recently discovered threats,
selecting emails in the output queue of the apparatus with destination IP addresses of the email server,
scanning the selected emails output queue of the apparatus for the most recently discovered threats, and
transferring email that pass the scanning step to the email server interface.

11. A method for operating an apparatus for protecting an email server from viruses and spam, the apparatus comprising:
an email queue store;
a plurality of spam filtration circuits;
an inbound email reception circuit;
an inbound virus filtration circuit;
an outbound email transmission circuit;
an outbound virus afterburner circuit; and
a most recent virus signature syndication reader circuit
the method comprising the following processes:
receiving inbound email addressed to a certain destination IP address,
storing received email into an email queue store,
scanning email in email queue store with inbound spam and virus filters,
disposing of email failing spam and virus filters
marking email ready for outbound transmission which do not fail spam and virus filters,
on the condition that the outbound email transmission circuit determines that a destination email server is available,
retrieving most recently detected virus signatures from a virus reference syndication server,
selecting all mail in the email queue store marked ready for outbound email transmission to the destination email server IP address,
rescanning selected email with most recently detected virus signatures in a virus afterburner circuit, and
transmitting only selected email which pass the rescanning step to the destination email server.

12. The method of claim 11, wherein disposing of email comprises marking for quarantine, and notifying a user, on the condition that the user wishes to view the quarantine, further comprising the steps:
retrieving most recently detected virus signatures from a virus reference syndication server,
selecting all mail in the email queue store marked for quarantine addressed to the user,
rescanning selected email with most recently detected virus signatures in a virus afterburner circuit, and
displaying only selected email which pass the rescanning step to the user.

13. The method of claim 11 further comprising the steps:
computing and recording a signature into a header of an email whereby rescanning for a virus signature can be done without recomputing a signature.

14. The method of claim 11 further comprising
retaining an email and its id after transmission to the destination email server,
scanning recently transmitted emails upon the condition that most recently detected virus signatures are received after transmission,
marking said emails as infected with a virus and
within a circuit in a client:
retrieving a unique identifier or unique identification listing of a recently transmitted email before displaying said email infected with a virus.

15. The method of claim 11 further comprising the step:
upon the condition that a user forwards an email to another user,
retrieving most recently detected virus signatures from a virus reference syndication server,
selecting all mail which the user wants to forward,
rescanning selected email with most recently detected virus signatures in a virus afterburner circuit, and
forwarding only selected email which pass the rescanning step to the destination email server.

16. The method of claim 11 further comprising the step:
upon the condition that a user moves an email from one folder to another,
retrieving most recently detected virus signatures from a virus reference syndication server,
selecting all mail in the email queue store which the user is moving,
rescanning selected email with most recently detected virus signatures in a virus afterburner circuit, and
moving only selected email which pass the rescanning step.

17. The method of claim 11 further comprising the step:
upon the condition that email is archived or saved:
retrieving most recently detected virus signatures from a virus reference syndication server,
selecting all mail in the email queue store which would be archived,
rescanning selected email with most recently detected virus signatures in a virus afterburner circuit, and
archiving only selected email which pass the rescanning step.

18. The method of claim 11 further comprising the step
upon the condition that the end-user transmits an smtp connect command to an email server:
retrieving most recently detected virus signatures from a virus reference syndication server,
selecting all mail in the email queue store marked ready for outbound email transmission to the destination email server IP address,
rescanning selected email with most recently detected virus signatures in a virus afterburner circuit, and
transmitting only selected email which pass the rescanning step to the destination email server.

19. The method of claim 11 further comprising the step
upon the condition that the end-user transmits a pop or imap retrieve command to an email server:
retrieving most recently detected virus signatures from a virus reference syndication server,
selecting all mail in the email queue store marked ready for outbound email transmission to the destination email server IP address,
rescanning selected email with most recently detected virus signatures in a virus afterburner circuit, and
transmitting only selected email which pass the rescanning step to the destination email server.
